(19) United States
(12) Patent Application Publication
(10) Pub. No.: US 2024/0143659 A1
(43) Pub. Date: May 2, 2024

(54) RECOMMENDATION OF ENTRY COLLECTIONS BASED ON MACHINE LEARNING

(71) Applicant: Ancestry.com Operations Inc., Lehi, UT (US)

(72) Inventor: Xiaoxuan Zhang, San Francisco, CA (US)

(21) Appl. No.: 17/974,382

(22) Filed: Oct. 26, 2022

(51) Int. Cl. G06F 16/903; G06F 16/9038

(52) U.S. Cl. CPC G06F 16/90335; G06F 16/9038

(57) ABSTRACT

A system or method for recommending one or more entry collections based on a query or a data entry. The method includes obtaining a query requesting information from a plurality of entry collections, extracting features from the query, and determining one or more entry collections among the plurality of entry collections that are likely to contain information related to the query based in part on the extracted features. The method further includes generating one or more links linking to the one or more entry collections, and causing the one or more links to be displayed to a user at a client device.

### FIELD

The disclosed embodiments relate to machine learning, more specifically to building and using a machine learning model to recommend entry collections for given queries or data entries.

### BACKGROUND

A large-scale data system such as a genealogy data system can include tens of thousands of entry collections (also referred to as data collections or record collections). Together, the tens of thousands of entry collections can include billions of data records. The tens of thousands of entry collections may be gathered via different sources, and/or contain data associated with persons who lived during different time frames and/or in different geographical areas. For instance, some of the entry collections are collected in European countries, some of the entry collections are collected in the US, some of the entry collections are collected from prison systems, some of the entry collections are collected from war memorial indexes, etc.

This type of database may allow users to build family trees, research their family history, and make meaningful discoveries about the lives of their ancestors. Users may try to identify relatives with datasets in the database. However, identifying relatives in the sheer amount of data is not a trivial task. Entry collections associated with different individuals may or may not be connected and/or related.

For any particular person, each of the tens of thousands of entry collections might potentially contain information related to the particular person. To find relevant data associated with the person, such as the person's ancestors or relatives, one could manually search each of the tens of thousands of entry collections. However, such a manual search is often infeasible due to the large number of entry collections. In some cases, even using a computer to compare or traverse tens of thousands of datasets without a concrete strategy may also be computationally infeasible, because such a search performed for a large number of users might consume too much resource, time, and/or network bandwidth.

### SUMMARY

Disclosed herein relates to methods for building and using a machine learning model to recommend entry collections for a given data entry or query. The method includes obtaining a query requesting information from a plurality of entry collections, and extracting features from the query, and determining one or more entry collections among the plurality of entry collections that are likely to contain information related to the query based in part on the extracted features. The method further includes generating one or more links linking to the one or more entry collections, and causing the one or more links to be displayed to a user at a client device.

In some embodiments, the method further includes receiving, from the user at the client device, a selection of a particular link of the one or more links, the particular link linking to a particular entry collection of the one or more entry collections. Responsive to the selection of the particular link, a particular query interface is launched to allow the user to perform queries in the particular entry collection of the one or more entry collections.

In some embodiments, generating the one or more links linking to the one or more entry collections further includes generating a query based on the dataset. For each of the one or more links, integrating the query in the link, linking to the corresponding entry collection, such that when the link is selected, the query is entered into the corresponding entry collection, causing the corresponding entry collection to generate a query result, and presenting the query result to the user at the client device.

In some embodiments, determining the one or more entry collections among the plurality of entry collections includes accessing a machine-learning model trained over data sets containing queries to the plurality of entry collections and query results. The machine-learning model is applied to the query. In particular, the machine-learning model takes the query as input and outputs the one or more entry collections.

In some embodiments, training the machine-learning model includes extracting a first set of features based on the plurality of entry collections, extracting a second set of features based on the queries, and identifying correlations between the first set of features, the second set of features, and search results of the queries. In some embodiments, extracting the first set of features based on the plurality of entry collections includes extracting features from metadata or field statistics of the plurality of entry collections.

In some embodiments, obtaining the query includes accessing a data entry in a database, and generating a query based on the data entry. In some embodiments, the database is a genealogy database, and the data entry is a person profile including one or more attributes associated with at least one of (1) a first name, (2) a last name, (3) a birth year, (4) a birth place, (5) a marriage year, (6) a marriage place, or (7) a residence place. The plurality of entry collections include entry collections containing genealogy data of different time frames and/or different geographical areas.

In some embodiments, the data entry is a node in a tree data structure. The tree data structure includes a plurality of nodes arranged hierarchically, and converting the data entry into a query includes traversing the tree data structure to identify at least one additional node corresponding to an additional data entry among the plurality of nodes, and converting the data entry and the at least one additional data entry into the query. In some embodiments, when the database is a genealogy database, the tree data structure may correspond to a family tree, and each node in the family tree is associated with a person profile of a family member.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure. In yet another embodiment, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

Figure (FIG. 1 illustrates a diagram of a system environment of an example computing system, in accordance with some embodiments.

FIG. 2 is a block diagram of an architecture of an example computing system, in accordance with some embodiments.

FIG. 3 illustrates an example training process for using training datasets to train machine learning model via a modeling engine in accordance with some embodiments.

FIG. 4 illustrates an example dataset 30 in accordance with some embodiments.

FIG. 5A illustrates an example user interface of an online genealogy system.

FIG. 5B illustrates an example process of batch processing user profiles stored in an individual profile store in accordance with some embodiments.

FIG. 5C illustrates an example family tree including a plurality of interconnected nodes.

FIG. 6 illustrates an example of a plurality of entry collections.

FIG. 7 is a block diagram of an example computing device, in accordance with some embodiments.

FIG. 8 is a flowchart of an example method for training a machine learning model for recommending a subset of entry collections for a given query.

FIG. 9 is a flowchart of an example method for recommending a subset of entry collection for a given query using a machine learning model.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A large-scale database such as a genealogy database can include tens of thousands of entry collections. Together, the tens of thousands of entry collections can include billions of data records. The tens of thousands of entry collections may be gathered via different sources, and/or contain data associated with persons who lived during different time frames and/or in different geographical areas. This type of database may allow users to build family trees, research their family history, and make meaningful discoveries about the lives of their ancestors. However, identifying relatives in the sheer number of entry collections, each containing a large amount of data, is not a trivial task, especially the tens of thousands of entry collections associated with different individuals may or may not be logically connected.

The principles described herein solve the above-described problem by training and/or using a machine learning model to recommend a subset of entry collections for any given query or data entry, where the subset of entry collections is likely to contain information related to the given data entry. As such, the user or the data system does not have to traverse each of tens of thousands of entry collections to determine whether a match is found. Instead, the user or the data system can only search or start their search from the recommended subset of entry collections, reducing resource consumption and/or network bandwidth consumption.

### Example System Environment

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as amplification and sequencing. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 performs sequencing of the biological samples and determines the base pair sequences of the individuals. The genetic data extraction service server 125 generates the genetic data of the individuals based on the sequencing results. The genetic data may include data sequenced from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from sequencing results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the genetic dataset of an individual. SNPs, base pair sequence, genotype, haplotype, RNA sequences, protein sequences, and phenotypes are examples of biomarkers.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed at the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to user's privacy setting and authorization, the computing server 130 may allow information generated from the user's genetic dataset to be linked to the user profile and to one or more of the family trees. The users may also authorize the computing server 130 to analyze their genetic dataset and allow their profiles to be discovered by other users.

### Example Computing Server Architecture

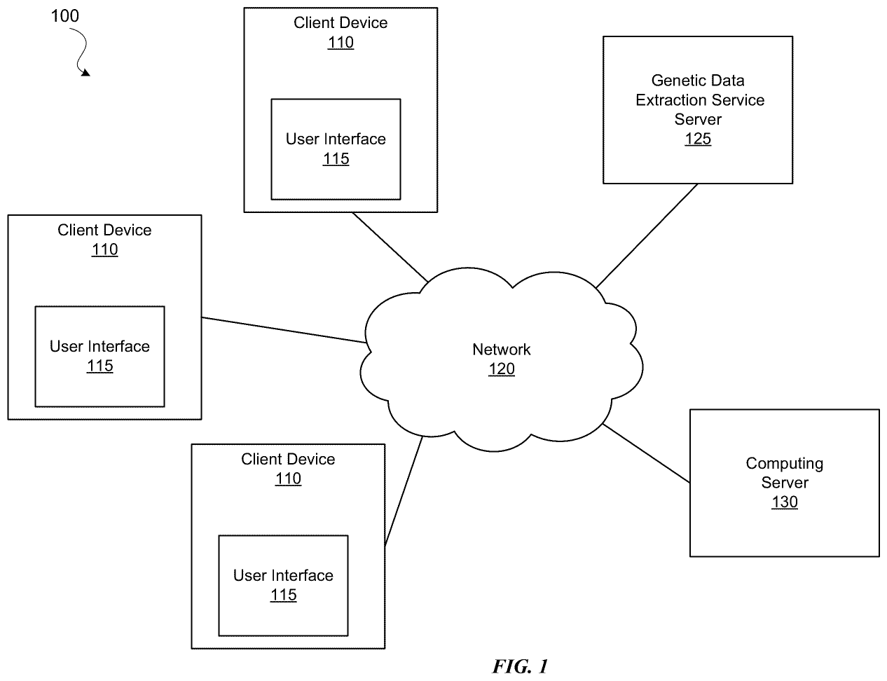

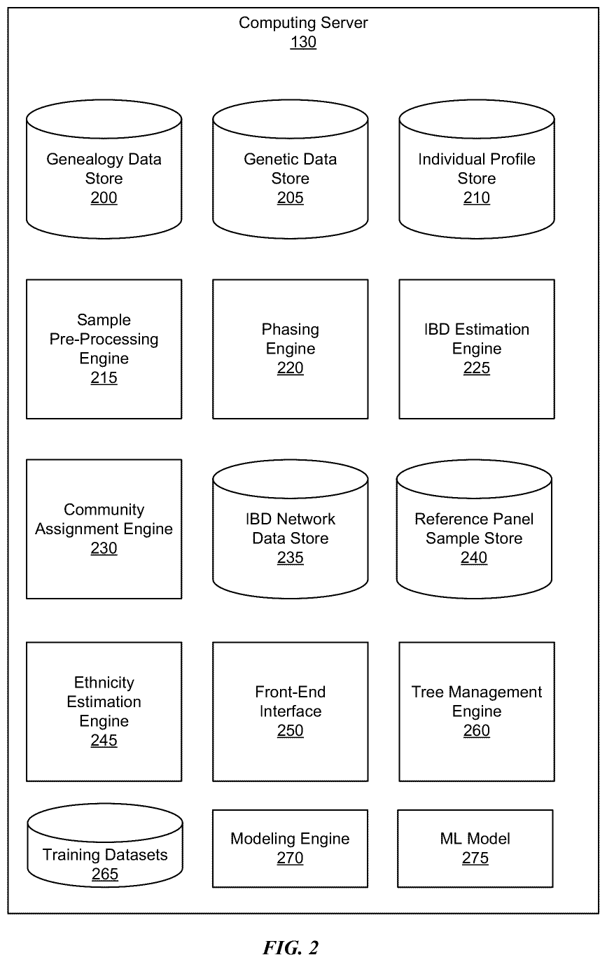

FIG. 2 is a block diagram of an architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, and a front-end interface 250. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birth place, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections among a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains genetic datasets of individuals in the genetic data store 205. A genetic dataset of an individual may be a digital dataset of nucleotide data (e.g., SNP data) and corresponding metadata. A genetic dataset may contain data on the whole or portions of an individual's genome. The genetic data store 205 may store a pointer to a location associated with the genealogy data store 200 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP loci (e.g., allele sites) filtered from the sequencing results. A SNP locus that is single base pair long may also be referred to a SNP site. A SNP locus may be associated with a unique identifier. The genetic dataset may be in a form of diploid data that includes a sequencing of genotypes, such as genotypes at the target SNP loci, or the whole base pair sequence that includes genotypes at known SNP loci and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating genetic datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, or preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g. stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and researches conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide the heightened privacy as a default setting for certain types of data, such as genetic data or any data that the user marks as sensitive. The user may opt in to sharing of those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from genetic data extraction service server 125. The genetic data extraction service server 125 may perform laboratory analysis of biological samples of users and generate sequencing results in the form of digital data. The sample pre-processing engine 215 may receive the raw genetic datasets from the genetic data extraction service server 125. The human genome mutation rate is estimated to be 1.1*10\hat{ }−8 per site per generation. This may lead to a variant of approximately every 300 base pairs. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's genetic dataset. In some embodiments, the SNPs may be autosomal SNPs. In some embodiments, 700,000 SNPs may be identified in an individual's data and may be stored in genetic data store 205. Alternatively, in some embodiments, a genetic dataset may include at least 10,000 SNP sites. In another embodiment, a genetic dataset may include at least 100,000 SNP sites. In yet another embodiment, a genetic dataset may include at least 300,000 SNP sites. In yet another embodiment, a genetic dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases diploid genetic dataset into a pair of haploid genetic datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's genetic datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their genetic datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, genetic datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's genetic dataset belongs or does not belong to the community of interest. A multi-class classifier such as a neural network may also be trained to determine whether the target individual's genetic dataset most likely belongs to one of several possible genetic communities.

Reference panel sample store 240 stores reference panel samples for different genetic communities. A reference panel sample is a genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various machine learning models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors are born at a certain birth place. The computing server 130 may also draw sequence data from the Human Genome Diversity Project (HGDP). Various candidates may be manually screened based on their family trees, relatives' birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of a genetic dataset of a target individual. The genetic datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target genetic dataset into a plurality of windows (e.g., about 1000 windows). Each window includes a small number of SNPs (e.g., 300 SNPs). The ethnicity estimation engine 245 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target genetic dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target genetic dataset by determining the label compositions of the nodes that are included in the determined path. U.S. Pat. No. 10,558,930, entitled “Local Genetic Ethnicity Determination System,” granted on Feb. 11, 2020, describes example embodiments of ethnicity estimation.

The front-end interface 250 displays various results determined by the computing server 130. The results and data may include the IBD affinity between a user and another individual, the community assignment of the user, the ethnicity estimation of the user, phenotype prediction and evaluation, genealogy data search, family tree and pedigree, relative profile and other information. The front-end interface 250 may allow users to manage their profile and data trees (e.g., family trees). The users may view various public family trees stored in the computing server 130 and search for individuals and their genealogy data via the front-end interface 250. The computing server 130 may suggest or allow the user to manually review and select potentially related individuals (e.g., relatives, ancestors, close family members) to add to the user's data tree. The front-end interface 250 may be a graphical user interface (GUI) that displays various information and graphical elements. The front-end interface 250 may take different forms. In one case, the front-end interface 250 may be a software application that can be displayed on an electronic device such as a computer or a smartphone. The software application may be developed by the entity controlling the computing server 130 and be downloaded and installed on the client device 110. In another case, the front-end interface 250 may take the form of a webpage interface of the computing server 130 that allows users to access their family tree and genetic analysis results through web browsers. In yet another case, the front-end interface 250 may provide an application program interface (API).

The tree management engine 260 performs computations and other processes related to users' management of their data trees such as family trees. The tree management engine 260 may allow a user to build a data tree from scratch or to link the user to existing data trees. In some embodiments, the tree management engine 260 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 260 may receive a genetic dataset from the target individual as input and search related individuals that are IBD-related to the target individual. The tree management engine 260 may identify common ancestors. Each common ancestor may be common to the target individual and one of the related individuals. The tree management engine 260 may in turn output potential family trees to which the target individual may belong by retrieving family trees that include a common ancestor and an individual who is IBD-related to the target individual. The tree management engine 260 may further identify one or more probable positions in one of the potential family trees based on information associated with matched genetic data between the target individual and DNA test takers in the potential family trees through one or more machine learning models or other heuristic algorithms. For example, the tree management engine 260 may try putting the target individual in various possible locations in the family tree and determine the highest probability position(s) based on the genetic datasets of the target individual and other DNA test takers in the family tree and based on genealogy data available to the tree management engine 260. The tree management engine 260 may provide one or more family trees from which the target individual may select. For a suggested family tree, the tree management engine 260 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 260 may automatically search, rank, and suggest individuals for the user conduct manual reviews as the user makes progress in the front-end interface 250 in building the family tree.

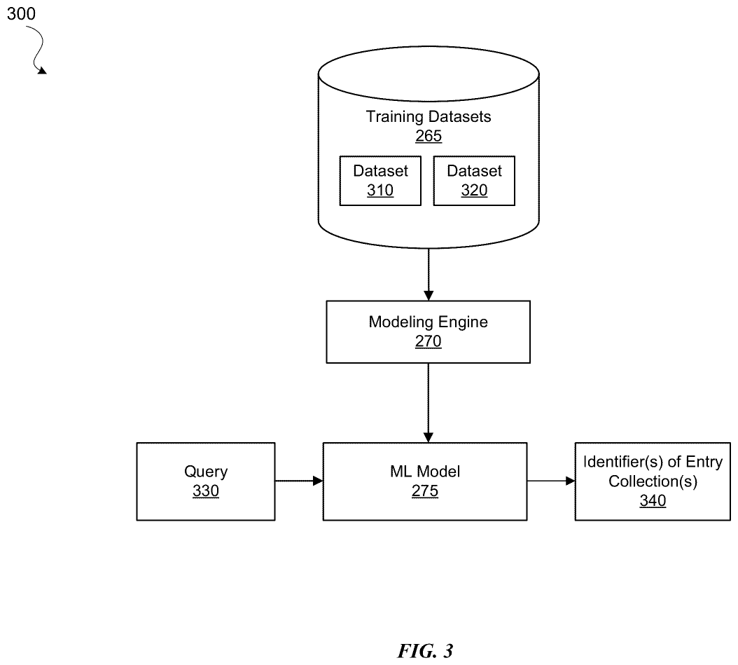

The computing server 130 further includes training datasets 265, a modeling engine 270, and a machine learning model 275. The modeling engine 270 uses the training datasets 265 to train the machine-learning model 275. The machine learning model 275 is trained in a particular manner, such that for a given query or a given data entry (e.g., a data entry in the individual profile store 210), the machine learning model 275 is configured to determine one or more entry collections among a plurality of entry collections (e.g., entry collections in genealogy data store 200, genetic data store 205). The one or more entry collections are likely to contain information related to the query or the data entry. Additional details related to the training datasets 265, modeling engine 270, and the machine learning model 275 are further described below with respect to FIG. 3.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Patent Publication Application No., entitled “Linking Individual Datasets to a Database,” US2021/0216556, published on Jul. 15, 2021, describes example embodiments of how an individual may be linked to existing family trees.

### Example Collection Recommendation Process

FIG. 3 illustrates an example training process 300 for using training datasets 265 to train machine learning model 275 via a modeling engine 270 in accordance with some embodiments. The training datasets 265 include a plurality of datasets 310, 320. In some embodiments, each of the plurality of datasets 310, 320 includes a query, an identifier of an entry collection (among a plurality of entry collections) in which the query is performed, and a query result.

An entry collection (also referred to as “data collection” or “record collection”) is a collection of data entries that are collected or gathered from a particular source and/or using a particular method. For example, an entry collection in genealogy may be collected by a local government in a geographical area when birth certificates or death certificates are issued. Different local governments may collect and maintain their own entry collections with similar or different formats of data entries. As another example, an entry collection may be collected by a prison system in a geographical area when prisoners are entered, released, and/or died in prison.

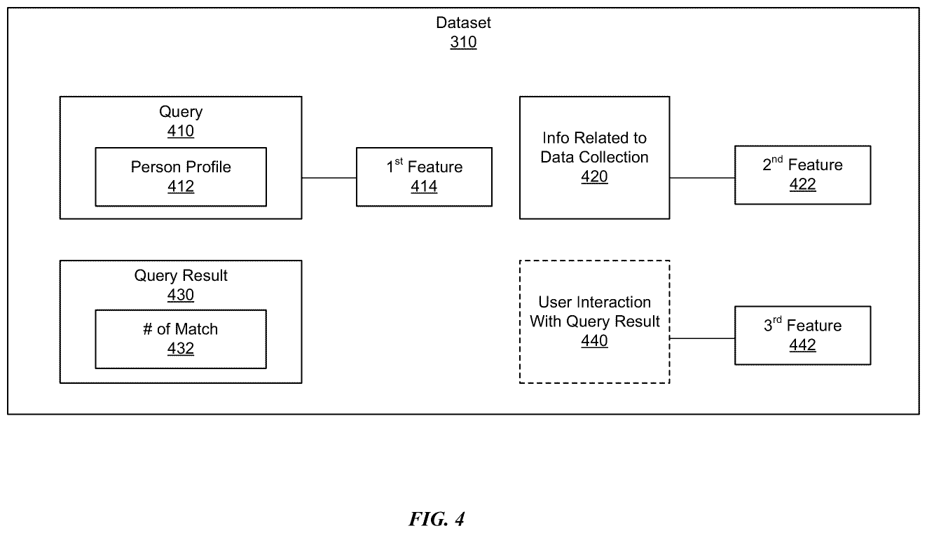

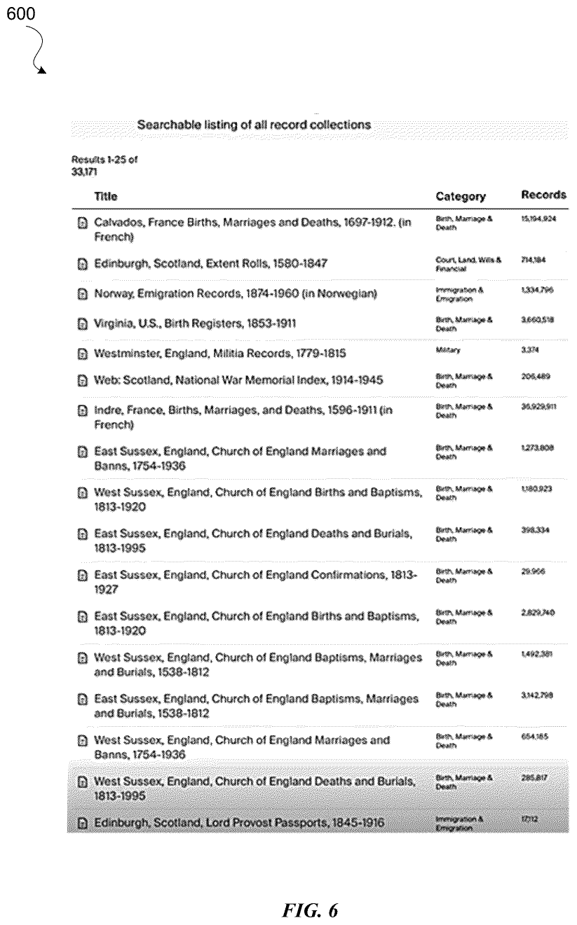

Due to the differences in time, geographical locations, and/or governing entities of these different entry collections, it is often difficult and/or undesirable to merge all the different entry collections into a single collection. As such, to search particular information thoroughly, each of the multiple entry collections might be queried separately, although some entry collections may return some search results, while others may not. Each dataset 310, 320 includes such a query, an identifier of an entry collection, and a query result. In some embodiments, query result may indicate whether a search result is returned by the query performed over the entry collection, a number of search results returned, and/or detailed information related to the search results. Additional details about the entry collections are further discussed with respect to FIG. 6, and additional details about each training dataset 310 or 320 are further discussed with respect to FIG. 4.

The modeling engine 270 is configured to process the training datasets 310, 320 to identify correlations between the queries, the entry collections, and the query results, and generate a machine learning model 275. In some embodiments, a first set of features are extracted from the queries, and a second set of features are extracted from the plurality of entry collections. The first set of features and the second set of features form each training dataset 310, 320. The machine learning model 275 is trained in a particular manner, such that the machine learning model 275 is configured to take any given query 330 as an input, and output one or more identifiers 340 of one or more entry collections among the plurality of entry collections that are likely to contain information related to the query 330.

FIG. 4 illustrates an example dataset 310 in accordance with some embodiments. The dataset 310 may be anyone of datasets in the training datasets 265 illustrated in FIG. 3. The dataset 310 includes a query 410 that is requested against a particular entry collection among a plurality of entry collections. The dataset 310 also includes information related to the particular entry collection 420. For example, in some embodiments, the query 410 includes or is a person profile 412, and the plurality of entry collections are different entry collections associated with genealogies of persons in different time frames and/or different geographical areas. Note, the query 410 may be intentionally entered by a user, automatically generated based on a person profile 412, and/or systematically performed by the computing server 130. For example, in some embodiments, a user may manually review the entry collections and select one or more entry collections to perform query or search. In some embodiments, the computing server 130 may be configured to generate a query, traversing each or a subset of the data collections when a person profile 412 is displayed for a user, or a new person profile 412 is created. In some embodiments, the computing server 130 may be tasked to use a set of user profiles to generate queries and traverse each of the entry collections and/or a subset of the entry collections systematically.

The dataset 310 also includes a query result 430, which is a result of the query 410 that is requested against the particular entry collection. For example, the query result 430 may indicate whether a match is found in the particular entry collection 420, or a number of matches 432 is found in the particular entry collection. In some embodiments, the dataset 310 may also include user interaction information 440, indicating whether the user has interacted with any one of the matches, such as click action, hover over action, etc.

In some embodiments, a first set of features 414 are extracted from the query 410, and a second set of features 422 are extracted from the information related to the particular entry collection 420. For example, when the query 410 includes a person profile 412, the first set of features 414 may include (but are not limited to) person names (e.g., first name or second name), year of birth, month of birth, date of birth, marriage year, marriage place, residence place, etc. The information related to the particular entry collection 420 may include (but is not limited to) metadata of the particular entry collection 420, and the second set of features 422 may be extracted from (but not limited to) the metadata and/or field statistics of the particular entry collection, such as geographical location or time frame associated with the particular entry collection. For example, a particular entry collection may include a first field related to a geographical location of each data entry, and a second field related to a time frame of each data entry. A first set of field statistical data associated with geographical locations and a second set of field statistical data associated with time frames may be computed and stored as metadata of the entry collection. For instance, a first set of field statistical data may indicate that a first percentage of data entries is associated with a first geographical location, that a second percentage of data entries is associated with a second geographical location, and so on and so forth. The second set of field statistical data may indicate that a third percentage of data entries is associated with a first time frame, a fourth percentage of data entries are associated with a second time frame, and so on and so forth. When a person profile 412 or a query 410 includes the first geographical location and the first time frame, the particular entry collection may be identified as a candidate entry collection, because the first geographical location and the first time frame are included in the field statistical data associated therewith.

In some embodiments, the pairs of the first set of features 414 and the second set of features 422 are used as training datasets 265. The modeling engine 270 is configured to process the pairs of features 414, 422 to identify correlations therebetween to generate or train a machine learning model 275. In some embodiments, the machine learning model 275 is trained based on a gradient boosting machine learning framework, such as (but not limited to) CatBoost. When a new query 330 is received, a new first set of features are extracted from the new query 330, and the new first set of features are received by the machine-learning model 275 as an input. The machine-learning model 275 identifies one or more entry collections among the plurality of entry collections based on the new second set of features.

In some embodiments, a third set of features 442 may also be extracted from the user interaction 440 with the query result. The third set of features 442 may also be used to train the machine-learning model 275. For example, the query results that are clicked by users are likely to be more relevant to the query. Such query results may be given a greater weight than the query results that are not interacted with by users.

The above-described principle may be implemented in any application where a plurality of entry collections are present. As briefly discussed above, one of such applications is person profiles associated with genealogy entry collections. For example, in a genealogy system, each user is associated with a user profile. The genealogy system has access to a plurality of entry collections, each of which may be collected by different sources, and/or contain different or overlapping data entries. For example, a particular entry collection may include genealogy data associated with a particular time frame, and/or a particular geographical area. Users in such an online genealogy system may want to find relevant data associated with their ancestors or relatives. A user may try to manually search each of the plurality of entry collections to find such relevant data. Alternatively, the online system traverses each of the plurality of entry collections for the user to try to find such relevant data.

The principles described herein use a machine learning model to identify a subset of the entry collections that are likely to contain relevant data of a user, and recommend the subset of the entry collections to the user, such that the user can start their search from the suggested entry collection. In some embodiments, the system may display the subset of entry collections to the user as links. When the user clicks any one of the links, the user is taken to a query interface of a corresponding entry collection. In some embodiments, the links are integrated with a search query, and when the user clicks any one of the links, the user is taken to the results of the query requested against the corresponding entry collection. For example, such a link may be in the format of: https://www.onlinesystem.com/search/collections/collection_id/?name=person_name&birth=birth_year&residence=birth_place, where “collection_id” is replaced with an identifier of the entry collection, such as “2442”; “person_name” is replaced with a person name, such as “james wood”, and “birth_year” is replaced with a birth year, such as 1797.

Alternatively, or in addition, the system may automatically perform a search for the user, and present the relevant data to the user. In some embodiments, the identifiers of the subset of entry collections, the links, and/or the search results may be stored relationally with the data entry (such as the user profile). As such, the machine learning model only needs to be applied once, and the results can be accessed by users at any time thereafter. In some embodiments, all the data entries or a subset of data entries are batch processed by the machine learning model. Alternatively, or in addition, in some embodiments, the machine learning model is applied or reapplied, (1) when a data entry is accessed, added, or modified, (2) when an entry collection is modified, or a new entry collection is added, and/or (3) when the machine learning model is modified or improved.

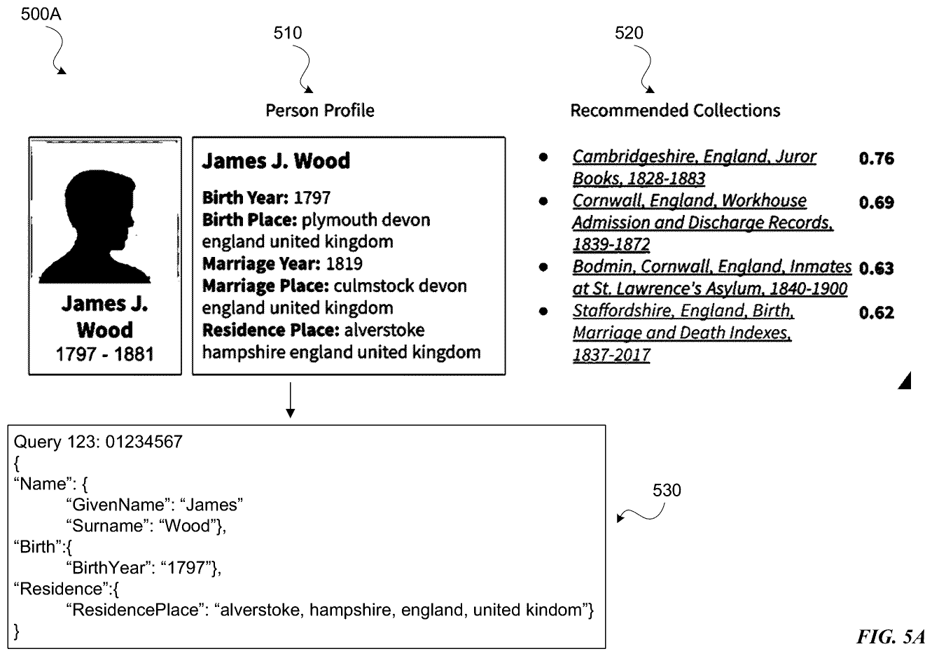

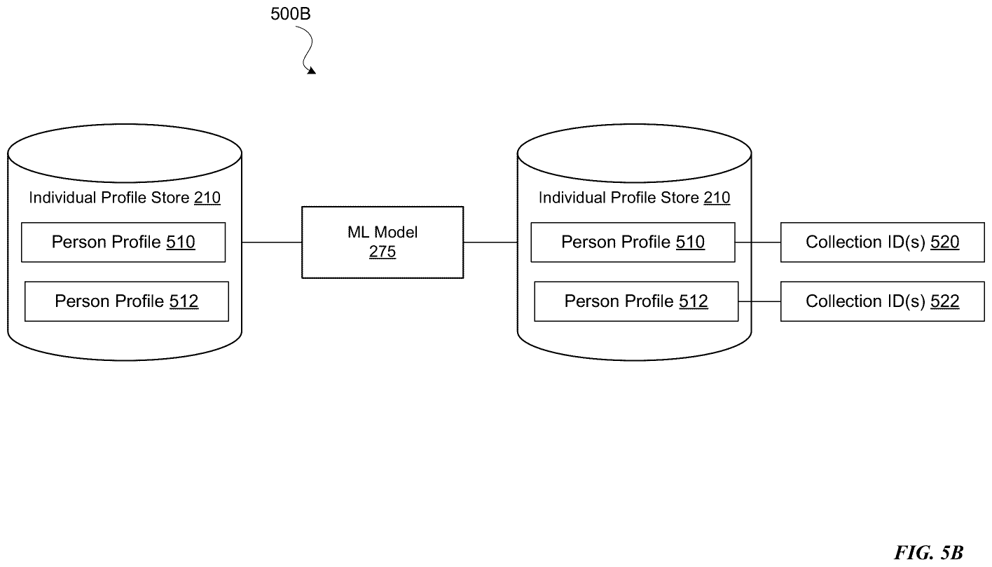

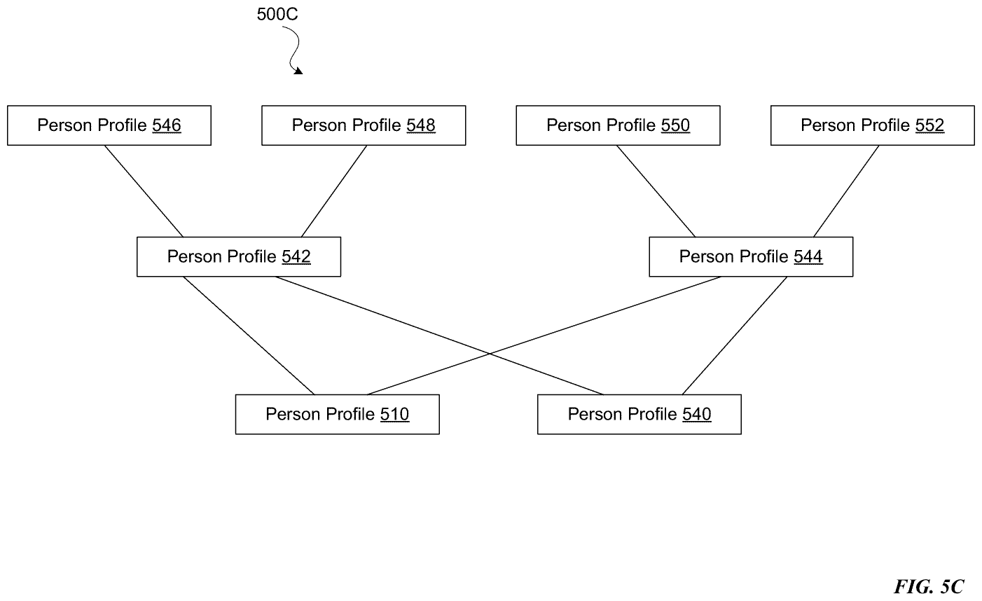

FIG. 5A illustrates an example user interface 500A of an online genealogy system. The user interface 500A includes a first portion 510 showing a person profile, and a second portion 520 showing recommended entry collections. As illustrated, the person profile includes a person name, James J. Wood; a birth year, 1797; a birth place, Plymouth DeVon, England, United Kingdom; a marriage year, 1819, a marriage place, Culmstock DeVon, England, United Kingdom; a residence place, Alverstoke, Hampshire, England, United Kingdom, etc. The recommended entry collections include four entry collections with their probabilities or scores, indicating a likelihood that the corresponding entry collection contains data related to the person profile. For example, the first entry collection is associated with Cambridgeshire, England, Juror Books, 1828-1883, with a probability or score 0.76; the second entry collection is associated with Cornwall, England, Workhouse Admission and Discharge Records, 1839-1872, with a probability or score 0.69; and so on and so forth.

In some embodiments, the online system is configured to generate a query 530 based on the person profile. The query 530 may be in a descriptive language. As illustrated in FIG. 5A, the query 530 is in JSON format, including a name element, a birth element, and a residence element.

In some embodiments, all the user profiles in the online system are batch processed to generate a subset of entry collections. The subsets of entry collections are stored relationally with the user profiles. In some embodiments, when a new user profile is generated, the machine learning model is applied to the new user profile to generate a subset of entry collections, and the subset of entry collections is stored relationally with the new user profile. In some embodiments, when a new entry collection is added to the repository of entry collections, the machine learning model is updated, and the updated machine learning model is reapplied to the user profiles to generate updated subset of entry collections.

FIG. 5B illustrates an example process 500B of batch processing user profiles stored in an individual profile store 210 in accordance with some embodiments. The individual profile store 210 stores a plurality of user or person profiles 510, 520. The machine learning model 275 is batch applied to each of the person profiles 510, 520 to generate subsets of entry collections that are likely to contain relevant data associated with the corresponding person profiles 510, 520. Each of the entry collections is associated with a collection identifier. In some embodiments, collection identifiers of the subsets of entry collections are stored relationally with the corresponding person profiles 510, 520. For example, when the machine learning model 275 is applied to person profile 510, a first subset of entry collections is identified, and collection IDs 520 of the first subset of entry collections is stored relationally with the person profile 510. Similarly, when the machine learning model 275 is applied to person profile 520, a second subset of entry collections are generated, and collection IDs 522 of the second subset of entry collections are stored relationally with the person profile 512.

In some embodiment, each person profile is associated with a tree structure, including a plurality of nodes arranged hierarchically. Each node corresponds to a data entry. For example, in a genealogy system, a person may be a part of a family tree, and each person in the family tree includes a person profile.

FIG. 5C illustrates an example family tree 500C including a plurality of interconnected nodes 510, 540, 542, 544, 546, 548, 550, 552. Each of the nodes 510, 540, 542, 544, 546, 548, 550, 552 is associated with a person profile. For example, person profiles 510 and 540 may be associated with two siblings. Person profiles 542 and 544 may be associated with parents of the two siblings. For example, person profile 542 may be associated with the father of the two siblings, and person profile 544 may be associated with the mother of the two siblings. The person profiles 546 and 548 may be associated with parents of the person associated with person profile 542, and paternal grandparents of the siblings associated with person profiles 510 and 540. Person profiles 550, 520 may be associated with parents of the person associated with person profile 544, and maternal grandparents of the siblings associated with person profiles 510 and 540.

In some embodiments, for a given user profile, the online system is configured to identify a tree structure that includes the user profile, identify all the nodes or a subset of the nodes (e.g., within a predetermined number of generations, or within certain number of links) in the tree structure, and apply the machine learning model 275 to each node person profile of the tree structure (or the subset of the nodes in the tree structure). For each node to which the machine learning model 275 is applied, the online system generates a subset of entry collections. The online system merges the different subsets of entry collections, and recommends the merged subsets of entry collections to a user. For example, in response to the user selecting (e.g., clicking on the family tree) a person profile, the online system may generate a query to search for recommended collections that are predicted to be relevant to the person profile.

In some embodiments, the recommendation of collections are displayed in response to a user building or viewing a family tree, whether the tree is a public or private tree that is related or not related the user.

Notably, a tree structure may be a common data structure implemented in a genealogy system. However, the principles described herein may also be implemented at other data systems which may use different formats of data structures to link different data entries. Regardless the formats of the data structures, for a given data entry, related data entries may be identified, and the related data entries may all be processed by the machine learning model to identify a subset of entry collections that are likely to contain information related to the given data entry.

FIG. 6 illustrates an example plurality of entry collections 600 related to genealogy. As illustrated, the plurality of entry collections 600 may include tens of thousands of entry collections. Each of the tens of thousands of entry collections contain genealogy data collected by a particular source, for persons in a particular geographical area and/or lived in a particular timeframe. For any given user, it is a significant number of tasks to manually or even automatically search each of the tens of thousands of entry collections. The principles described herein solve this problem by recommending a subset of entry collections that are likely to contain relevant information, reducing the computational power, time, and/or network bandwidth required to traverse through each of the tens of thousands of entry collections for any given query. For example, for each particular searched-for person, usually only 10-20 entry collections are pertinent to the person. Thus, the vast majority of the thousands of entry collections are likely not relevant, and identifying likely fruitful areas for search provides great benefits to individual users and researchers. Further, as running a search over the entire collection corpus having thousands of entry collections is extremely expensive, the principles described herein also significantly reduce the workload, network bandwidth utilization, or computing resource utilization of the computing server 130. Assuming 10-20 entry collections are pertinent to a person, and a total number of entry collections is more than 33,000, the principles described herein would provide a 99.94%-99.97% reduction of workload and network and computing resource utilization.

### Computing Machine Architecture

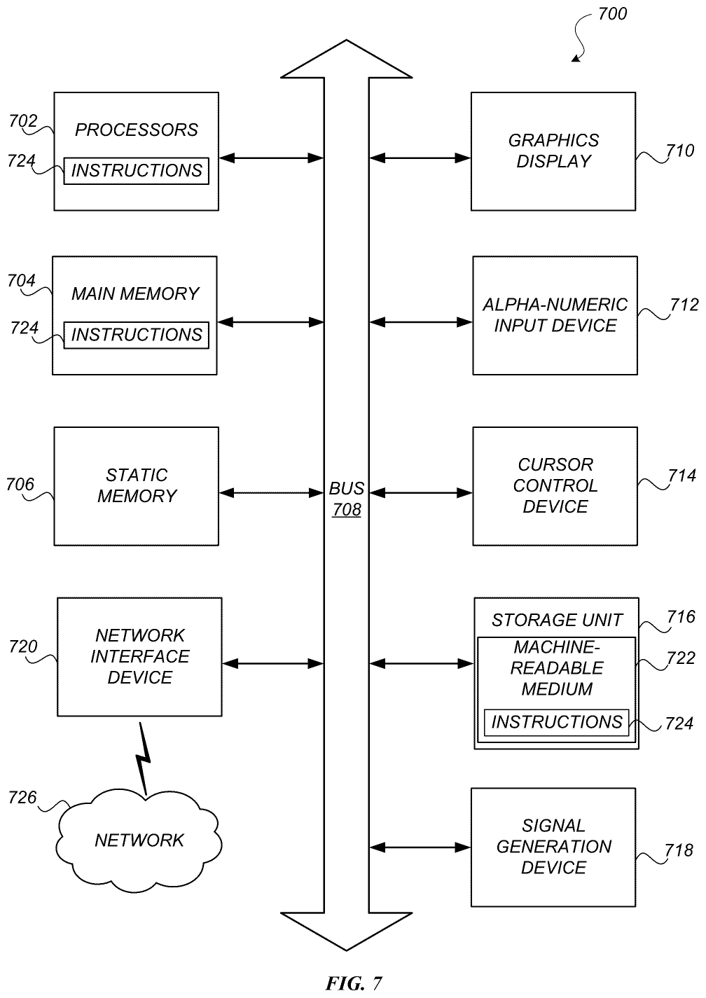

FIG. 7 is a block diagram illustrating components of an example computing machine that is capable of reading instructions from a computer-readable medium and execute them in a processor (or controller). A computer described herein may include a single computing machine shown in FIG. 7, a virtual machine, a distributed computing system that includes multiple nodes of computing machines shown in FIG. 7, or any other suitable arrangement of computing devices.

By way of example, FIG. 7 shows a diagrammatic representation of a computing machine in the example form of a computer system 700 within which instructions 724 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 7 may correspond to any software, hardware, or combined components shown in FIGS. 1 and 2, including but not limited to, the client device 110, the computing server 130, and various engines, interfaces, terminals, and machines shown in FIG. 2. While FIG. 7 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 724 that specify actions to be taken by that machine. Further, while only a single machine is illustrated, the term “machine” and “computer” may also be taken to include any collection of machines that individually or jointly execute instructions 724 to perform any one or more of the methodologies discussed herein.

The example computer system 700 includes one or more processors 702 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 700 may also include a memory 704 that store computer code including instructions 724 that may cause the processors 702 to perform certain actions when the instructions are executed, directly or indirectly by the processors 702. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 702 and reduces the space required for the memory 704. For example, the database processing techniques and machine learning methods described herein reduce the complexity of the computation of the processors 702 by applying one or more novel techniques that simplify the steps in training, reaching convergence, and generating results of the processors 702. The algorithms described herein also reduces the size of the models and datasets to reduce the storage space requirement for memory 704.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors.

The computer system 700 may include a main memory 704, and a static memory 706, which are configured to communicate with each other via a bus 708. The computer system 700 may further include a graphics display unit 710 (e.g., a plasma display panel (PDP), a liquid crystal display (LCD), a projector, or a cathode ray tube (CRT)). The graphics display unit 710, controlled by the processors 702, displays a graphical user interface (GUI) to display one or more results and data generated by the processes described herein. The computer system 700 may also include alphanumeric input device 712 (e.g., a keyboard), a cursor control device 714 (e.g., a mouse, a trackball, a joystick, a motion sensor, or other pointing instruments), a storage unit 716 (a hard drive, a solid-state drive, a hybrid drive, a memory disk, etc.), a signal generation device 718 (e.g., a speaker), and a network interface device 720, which also are configured to communicate via the bus 708.

The storage unit 716 includes a computer-readable medium 722 on which is stored instructions 724 embodying any one or more of the methodologies or functions described herein. The instructions 724 may also reside, completely or at least partially, within the main memory 704 or within the processor 702 (e.g., within a processor's cache memory) during execution thereof by the computer system 700, the main memory 704 and the processor 702 also constituting computer-readable media. The instructions 724 may be transmitted or received over a network 726 via the network interface device 720.

While computer-readable medium 722 is shown in an example embodiment to be a single medium, the term “computer-readable medium” should be taken to include a single medium or multiple media (e.g., a centralized or distributed database, or associated caches and servers) able to store instructions (e.g., instructions 724). The computer-readable medium may include any medium that is capable of storing instructions (e.g., instructions 724) for execution by the processors (e.g., processors 702) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Example Method for Training a Machine Learning Model for Recommending a Subset of Entry Collections for a Given Query

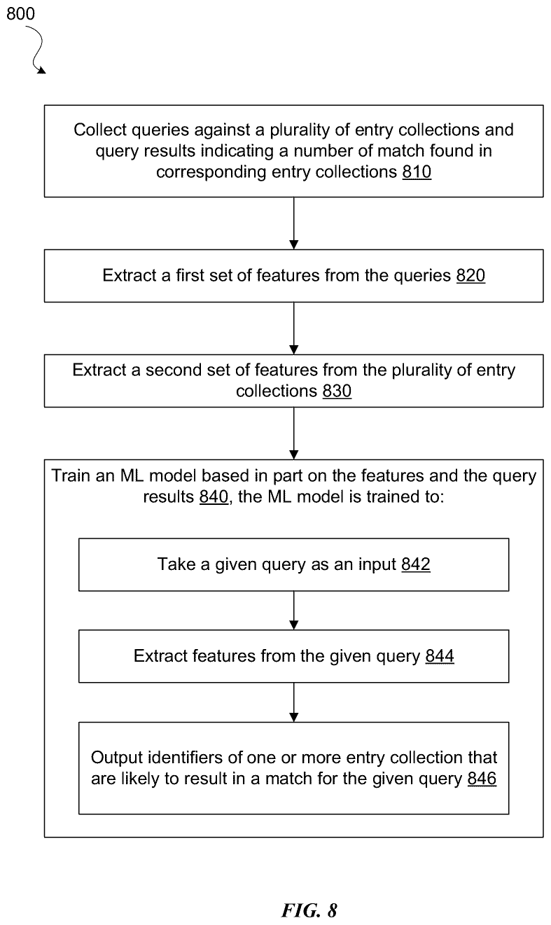

FIG. 8 is a flowchart of an example method 800 for training a machine learning model for recommending a subset of entry collections for a given query. The method 800 may be performed at the genetic data extraction service server 125, computing server 130, and/or any online system that has access to queries.

The computing server collects 810 queries against a plurality of entry collections and query results indicating a number of matches found in corresponding entry collections. The queries may be manually entered by users or batch requested by the computing server. For example, users of a genealogy system may randomly or selectively enter a query into a particular entry collection. Results of such queries may be recorded in log of the genealogy system and/or the user profiles of the genealogy system. Alternatively, the computing server may batch generate a number of queries based on user profiles, and collects the results of the queries. Regardless of whether the queries are manually generated by users or batch generated by the computing server, such queries and their results may be used as training datasets.

The computing server then extracts 820 a first set of features from the queries. The first set of features may correspond to the first set of features 414 of FIG. 4. When the query includes a person profile (e.g., person profile 510 of FIG. 5A), the first set of features may include person names, birth year, birth place, marriage year, marriage place, residence place, etc.

The computing server also extracts 830 a second set of features from the plurality of entry collections. In some embodiments, the second set of features are extracted from metadata of the plurality of entry collections. In some embodiments, the second set of features include field statistics of the plurality of entry collections.

The computing server then trains 840 a machine learning model based in part on the first set of features, the second set of features, and the search results. For example, a first set of features are extracted from a particular query against a particular entry collection. A second set of features are extracted from metadata or field statistics of the particular entry collection. A search result is associated with the particular query against the particular entry collection. In some embodiments, the search result includes a number of match found in the particular entry collection.

The machine learning model is trained to take 842 a given query as an input, extract 844 a new first set of features from the given query, and output 846 identifiers of one or more entry collections that are likely to result in a match for the given query. For example, when the query is associated with a person profile, the new first set of features may include person names, birth year, birth place, marriage year, marriage place, residence place associated with the person profile.

### Example Method for Recommending a Subset of Entry Collections for a Given Query Using a Machine Learning Model

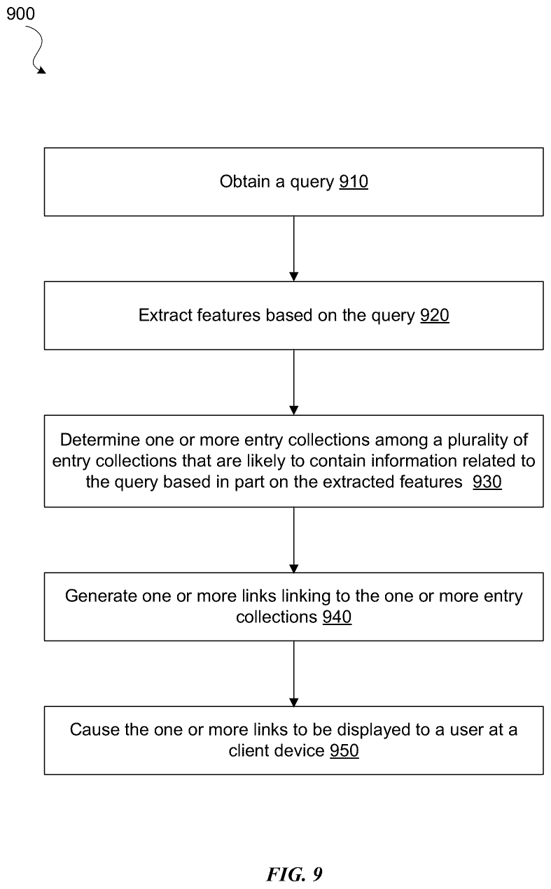

FIG. 9 is a flowchart of an example method 900 for recommending a subset of entry collection for a given query using a machine learning model. The method 900 may be performed at the genetic data extraction service server 125, computing server 130, and/or any online system that has access to queries. In some embodiments, the method 900 may be batch performed for all person profiles at the online system. Alternatively, or in addition, the method 900 may be performed when a new user profile is generated, or when a user input requests for recommendation of a subset of entry collections.

The online system is configured to obtain 910 a query requesting information from a plurality of entry collections. In some embodiments, the query is generated based on a data entry of a database. In some embodiments, the database is a genealogy database, and the data entry is a person profile. The person profile may include one or more attributes, such as (but not limited to) (1) a first name, (2) a last name, (3) a birth year, (4) a birth place, (5) a marriage year, (6) a marriage place, and/or (7) a residence place. For example, the user profile may correspond to user profile 510 of FIG. 5C, and a query may correspond to query 530 of FIG. 5C. The query may be in descriptive language, such as JSON.

The online system then extracts 920 a set of features based on the query. For example, when the query is associated with a person profile, the new first set of features may include person names, birth year, birth place, marriage year, marriage place, residence place associated with the person profile.

The online system then determines 930 one or more entry collections among a plurality of entry collections that are likely to contain information related to the data entry based in part on the set of features. In some embodiments, a pretrained machine learning model (such as machine learning model 275) is applied to the set of features to output identifiers of the one or more entry collections.

The online system then generates 940 one or more links linking to the one or more entry collections. In some embodiments, the one or more links are URLs links to web applications of the one or more entry collections that allow a user to query the one or more entry collections. In some embodiments, the one or more links further integrate the query associated with the user profile. When the user clicks each of the one or more links, the query is entered into a corresponding entry collection, and the user is presented one or more query results of the query requested against the corresponding entry collection. For example, such a link may be in the format of: https://www.onlinesystem.com/search/collections/collection_id/?name=person_name&birth=birth_year&residence=birth_place, where “collection_id” is replaced with an identifier of the entry collection, such as “2442”; “person_name” is replaced with a person name, such as “james wood”, and “birth_year” is replaced with a birth year, such as 1797.

The online system then causes 950 the one or more links to be displayed to a user at a client device. In some embodiments, the one or more links are displayed next to the user profile. For example, the graphical representation of the user profile may be similar to the portion of interface 510 of FIG. 5A, and the one or more links may be similar to the portion of interface 520 of FIG. 5A.

In some embodiments, once the one or more entry collections are identified, identifiers of the one or more entry collections, the links, and/or query results may be stored relationally with the data entry in the database. As such, when the user profile is accessed again, there is no need to apply the machine learning model again, and the relationally stored identifiers and/or links of the one or more entry collections may be retrieved and presented to the user again.

In some embodiments, a graphical user interface associated with an online system is caused to be displayed at a client device. The graphical user interface displays a graphical representation of a data tree including a plurality of nodes arranged hierarchically. The online system is configured to provide query pages of a plurality of record collections. Each record collection includes a plurality of records. A query page allows user queries of records in one or more record collections selected to be included in the query page. One of the record collections includes historical records that are digitalized as a digital collection of historical records. When a user selects through the graphical representation one or more nodes associated with the data tree, the online system determines a list of one or more record collections that are predicted to be related to the selected one or more nodes. The graphical user interface is then caused to display one or more links to the one or more record collections in the list. When the user selects one of the links, a particular query page is launched, where the particular query page allows the user to perform queries of one or more records that are associated with the selected one or more nodes.

Note, the principles described herein are not limited to genealogy entry collections or systems. The similar principles may be implemented in any large-scale data system that include multiple entry collections. The machine learning model may be batch applied to each of the data entries or a subset of the data entries in such a system. The machine learning model may be applied to each single data entry and/or related data entries, such as related data entries in a tree structure, or related data entries organized in any other form of data structure.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, and (6) U.S. Patent Publication Application No., entitled “Linking Individual Datasets to a Database,” US2021/0216556, published on Jul. 15, 2021.

What is claimed is:

1. A computer-implemented method for recommending one or more entry collections based on a query, comprising:
obtaining a query requesting information from a plurality of entry collections;
extracting features from the query;
determining one or more entry collections among the plurality of entry collections that are likely to contain the information related to the query based in part on the extracted features;
generating one or more links linking to the one or more entry collections; and
causing the one or more links to be displayed to a user at a client device.

2. The computer-implemented method of claim 1, the method further comprising:
receiving, from the user at the client device, a selection of a particular link of the one or more links, the particular link linking to a particular entry collection of the one or more entry collections; and
responsive to the selection of the particular link, launching a particular query interface that allows the user to perform queries in the particular entry collection of the one or more entry collections.

3. The computer-implemented method of claim 1, wherein generating the one or more links linking to the one or more entry collections includes, for each of the one or more links:
integrating the query in the link;
linking to a corresponding entry collection, such that when the link is selected, the query is entered into the corresponding entry collection;
causing the corresponding entry collection to generate a query result; and
presenting the query result to the user at the client device.

4. The computer-implemented method of claim 1, wherein determining the one or more entry collections among the plurality of entry collections includes:
accessing a machine-learning model trained over datasets containing queries to the plurality of entry collections and query results;
applying the machine-learning model to the query, the machine-learning model taking the query as input and outputting the one or more entry collections.

5. The computer-implemented method of claim 4, wherein training the machine-learning model includes:
extracting a first set of features based on the plurality of entry collections;
extracting a second set of features based on the queries; and
identifying correlations between the first set of features, the second set of features, and search results of the queries.

6. The computer-implemented method of claim 5, wherein extracting the first set of features based on the plurality of entry collections includes extracting features from metadata or field statistics of the plurality of entry collections.

7. The computer-implemented method of claim 1, wherein obtaining the query includes:
accessing a data entry in a database; and
converting the data entry into a query;
wherein identifiers of the one or more entry collections are stored relationally with the data entry in the database.

8. The computer-implemented method of claim 7, wherein the database is a genealogy database, and the data entry is a person profile including one or more attributes associated with at least one of (1) a first name, (2) a last name, (3) a birth year, (4) a birth place, (5) a marriage year, (6) a marriage place, or (7) a residence place.

9. The computer-implemented method of claim 1, wherein the plurality of entry collections include entry collections containing genealogy data of different time frames or different geographical areas.

10. The computer-implemented method of claim 7, wherein the data entry is a node in a tree data structure, the tree data structure comprises a plurality of nodes arranged hierarchically, and converting the data entry into a query includes:
traversing the tree data structure to identify at least one additional node corresponding to an additional data entry among the plurality of nodes;
converting the data entry and the at least one additional data entry into the query.

11. A computer system, comprising:
a processor; and
a non-transitory computer-readable storage medium containing computer program code that, when executed by the processor, causes the processor to:
obtain a query requesting information from a plurality of entry collections;
extract features from the query;
determine one or more entry collections among the plurality of entry collections that are likely to contain the information related to the query based in part on the extracted features;
generate one or more links linking to the one or more entry collections; and
cause the one or more links to be displayed to a user at a client device.

12. The computer system of claim 11, wherein the non-transitory computer-readable storage medium further contains computer program code that, when executed by the processor, causes the processor to:
receive, from the user at the client device, a selection of a particular link of the one or more links, the particular link linking to a particular entry collection of the one or more entry collections; and
responsive to the selection of the particular link, launch a particular query interface that allows the user to perform queries in the particular entry collection of the one or more entry collections.

13. The computer system of claim 11, wherein generating the one or more links linking to the one or more entry collections includes, for each of the one or more links:
integrating the query in the link;
linking to a corresponding entry collection, such that when the link is selected, the query is entered into the corresponding entry collection;
causing the corresponding entry collection to generate a query result; and
presenting the query result to the user at the client device.

14. The computer system of claim 11, wherein determining the one or more entry collections among the plurality of entry collections includes:
accessing a machine-learning model trained over datasets containing queries to the plurality of entry collections and query results;
applying the machine-learning model to the query, the machine-learning model taking the query as input and outputting the one or more entry collections.

15. The computer system of claim 14, wherein training the machine-learning model includes:
extracting a first set of features based on the plurality of entry collections;
extracting a second set of features based on the queries; and
identifying correlations between the first set of features, the second set of features, and search results of the queries.

16. The computer system of claim 15, wherein extracting the first set of features based on the plurality of entry collections includes extracting features from metadata or field statistics of the plurality of entry collections.

17. The computer system of claim 11, wherein obtaining the query includes:
accessing a data entry in a database; and
converting the data entry into a query; and
wherein identifiers of the one or more entry collections are stored relationally with the data entry in the database.

18. The computer system of claim 17, wherein the database is a genealogy database, and the data entry is a person profile including one or more attributes associated with at least one of (1) a first name, (2) a last name, (3) a birth year, (4) a birth place, (5) a marriage year, (6) a marriage place, or (7) a residence place.

19. The computer system of claim 11, wherein the plurality of entry collections include entry collections containing genealogy data of different time frames or different geographical areas.

20. The computer system of claim 17, wherein the data entry is a node in a tree data structure, the tree data structure comprises a plurality of nodes arranged hierarchically, and converting the data entry into a query includes:
traversing the tree data structure to identify at least one additional node corresponding to an additional data entry among the plurality of nodes;
converting the data entry and the at least one additional data entry into the query.
